(19) United States
(12) Patent Application Publication
(10) Pub. No.: US 2022/0210899 A1
(43) Pub. Date: Jun. 30, 2022

(54) GROUNDING STRUCTURE

(71) Applicant: CHIPBOND TECHNOLOGY CORPORATION, Hsinchu (TW)

(72) Inventors: Tzu-Long Chuang, Hsinchu City (TW); Hsin-Chieh Chuang, Hsinchu City (TW); Chia-Hsin Hsiao, Hsinchu County (TW); Tung-Li Tsai, Hsinchu City (TW)

(21) Appl. No.: 17/512,804

(22) Filed: Oct. 28, 2021

(30) Foreign Application Priority Data
Dec. 25, 2020 (TW) 109146223

(51) Int. Cl. H05F 3/02

(52) U.S. Cl. CPC H05F 3/02

(57) ABSTRACT

A grounding structure includes a flexible conductive webbing and a counterweight disposed on the flexible conductive webbing. The flexible conductive webbing is weaved from conductive wires, provided to be mounted on a carrier and electrically connected to the carrier. The counterweight is used to allow the flexible conductive webbing to contact a ground in a way of surface contact for electrostatic discharge.

### FIELD OF THE INVENTION

This invention relates to a grounding structure, and more particularly to a grounding structure including a flexible conductive webbing and a counterweight.

### BACKGROUND OF THE INVENTION

Electrostatic discharge (ESD) may cause malfunction or damage to electronic components or electronic systems. Conducting electrostatic charges to ground is a conventional approach used to prevent the occurrence of electrostatic discharge through electronic components or electronic systems. However, electronic components are usually trolleyed during manufacturing, assembling, testing or storage, and electrostatic charges may accumulate on the moving trolley to damage the electronic components placed on the trolley. In order to protect the electronic components placed on the trolley from damage caused by electrostatic discharge, it is necessary to consider how to conduct electrostatic charges accumulated on the moving trolley.

### SUMMARY

One object of the present invention is to allow a flexible conductive webbing mounted on a carrier to contact ground in a way of surface contact for conducting electrostatic charges from the carrier to ground such that the electronic component, like wafer and semiconductor package, is protected from damage caused by electrostatic discharge.

A grounding structure of the present invention includes a flexible conductive webbing and a counterweight. The flexible conductive webbing is weaved from a plurality of conductive wires and has a first contact end and a second contact end. The first contact end is provided to be connected to a carrier such that the flexible conductive webbing is electrically connected to the carrier, and the second contact end is hung on the carrier. The counterweight is disposed on the second contact end to allow a contact surface of the second contact end to contact a ground for conducting electrostatic charges from the carrier to the ground.

The grounding structure can contact ground in a way of surface contact by the counterweight disposed on the flexible conductive webbing. Consequently, the contact area and the fitness of the flexible conductive webbing on the ground are increased to improve electrostatic charge conducting effectiveness of the flexible conductive webbing.

### DESCRIPTION OF THE DRAWINGS

FIG. 1 is a perspective assembly diagram illustrating a grounding structure connected to a carrier in accordance with one embodiment of the present invention.

FIG. 2 is a cross-section view diagram illustrating the grounding structure in accordance with one embodiment of the present invention.

### DETAILED DESCRIPTION OF THE INVENTION

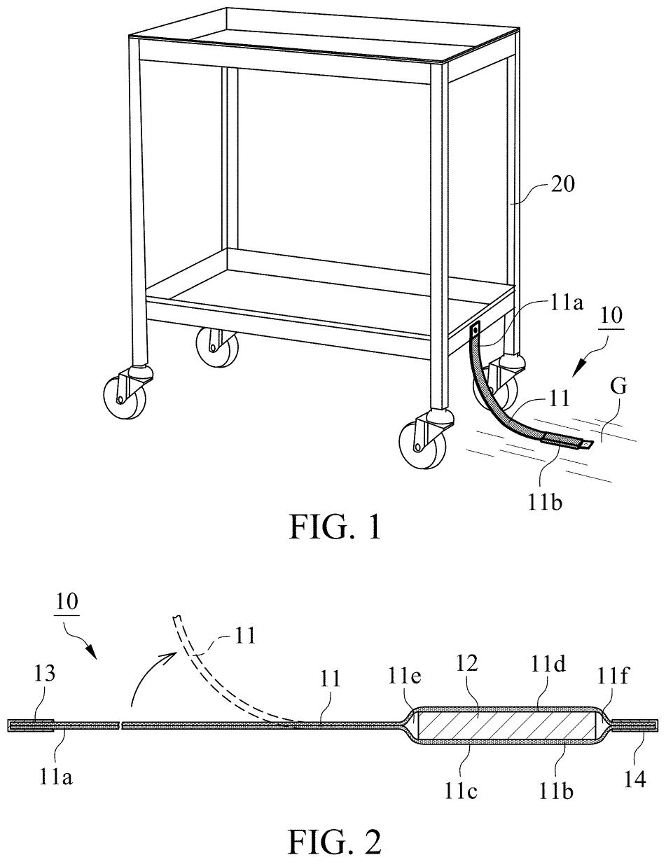

With reference to FIGS. 1 and 2, a grounding structure 10 of the present invention is mounted on a carrier 20 to conduct electrostatic charge away from electronic component placed on the carrier 20 such that the electronic component is protected from damage of electrostatic discharge. The carrier 20 can be immobile carrier (e.g. shelf and bench) or mobile carrier (e.g. trolley).

With reference to FIGS. 1 and 2, the grounding structure 10 includes a flexible conductive webbing 11 and a counterweight 12. The flexible conductive webbing 11 is weaved from a plurality of conductive wires which are preferably metal wires. In this embodiment, the conductive wires are stainless steel wires. The flexible conductive webbing 11 has a first contact end 11a and a second contact end 11b having a contact surface 11c, the first contact end 11a is used to connect with the carrier 20 such that the flexible conductive webbing 11 can be electrically connected to the carrier 20, and the second contact end 11b is hung on the carrier 20.

With reference to FIGS. 1 and 2, the counterweight 12 is positioned on the second contact end 11b of the flexible conductive webbing 11 and provided to allow the contact surface 11c of the second contact end 11b to touch a ground G for electrostatic discharge. In this embodiment, the counterweight 12 is made of metal such as stainless steel.

With reference to FIGS. 1 and 2, the flexible conductive webbing 11 in this embodiment includes a wire-weaved portion 11d, a space 11e and an opening 11f. The space 11e exists inside the wire-weaved portion 11d, and the opening 11f is located on the second contact end 11b and communicates with the space 11e. The counterweight 12 can be placed into the space 11e via the opening 11f such that it can contact the wire-weaved portion 11d of the flexible conductive webbing 11.

With reference to FIGS. 1 and 2, the grounding structure 10 further includes a mounting element 13 which is positioned on the first contact end 11a of the flexible conductive webbing 11. The mounting element 13 is provided to fix the flexible conductive webbing 11 on the carrier 20. In this embodiment, the mounting element 13 and the first contact end 11a are connected with each other. Because of the mounting element 13, the conductive wires on the first contact end 11a will not separate from one another, and the first contact end 11a can be electrically connected to the carrier 20.

With reference to FIGS. 1 and 2, the grounding structure 10 further includes a sealing element 14. In this embodiment, the sealing element 14 is connected to the second contact end 11b. Preferably, the sealing element 14 is provided to close the opening 11f, thereby preventing the counterweight 12 from dropping from the opening 11f of the flexible conductive webbing 11.

With reference to FIGS. 1 and 2, the counterweight 12 positioned on the second contact end 11b can make the grounding structure 10 contact the ground G in a way of surface contact so the contact area and fitness of the flexible conductive webbing 11 on the ground G are improved for electrostatic discharge. The grounding structure 10 can protect the electronic component (e.g. wafer and semiconductor package) placed on the carrier 20 from damage caused by electrostatic discharge.

While this invention has been particularly illustrated and described in detail with respect to the preferred embodiments thereof, it will be clearly understood by those skilled in the art that is not limited to the specific features shown and described and various modified and changed in form and details may be made without departing from the scope of the claims.

What is claimed is:

1. A grounding structure comprising:
a flexible conductive webbing weaved from a plurality of conductive wires and including a first contact end and a second contact end, the first contact end is configured to be connected to a carrier such that the flexible conductive webbing is configured to be electrically connected to the carrier, the second contact is configured to be hung on the carrier; and
a counterweight mounted on the second contact end and configured to allow a contact surface of the second contact end to contact a ground for electrostatic discharge.

2. The grounding structure in accordance with claim 1, wherein the flexible conductive webbing further includes a wire-weaved portion and a space, the space exists inside the wire-weaved portion, the counterweight is configured to be placed in the space to contact the wire-weaved portion.

3. The grounding structure in accordance with claim 2 further comprising a mounting element disposed on the first contact end, wherein the mounting element is configured to mount the flexible conductive webbing on the carrier.

4. The grounding structure in accordance with claim 3, wherein the first contact end is configured to be electrically connected to the carrier via the mounting element.

5. The grounding structure in accordance with claim 3 further comprising a sealing element, wherein the sealing element is configured to close an opening of the flexible conductive webbing, the opening is located on the second contact end and communicates with the space.

6. The grounding structure in accordance with claim 1, wherein the plurality of conductive wires are made of stainless steel.

7. The grounding structure in accordance with claim 1, wherein the counterweight is made of metal.
